(19) United States
(12) Patent Application Publication
(10) Pub. No.: US 2011/0029177 A1
(43) Pub. Date: Feb. 3, 2011

(54) Multi-Fuel and Electric-Drive Hybrid Power Train and Vehicle Using the Same

(75) Inventors: Yung Yeung, Bradbury, CA (US); Shishu Fu, Shenyang (CN); Chuantao Wang, Rochester, MI (US); Junwen Hou, Rochester, MI (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HYBRID KINETIC AUTOMOTIVE HOLDINGS, Pasadena, CA (US)

(21) Appl. No.: 12/844,443

(22) Filed: Jul. 27, 2010

Related U.S. Application Data
(60) Provisional application No. 61/229,737, filed on Jul. 30, 2009.

(51) Int. Cl. B60W 20/00; B60K 6/42

(52) U.S. Cl. 701/22; 180/65.22; 180/65.21

(57) ABSTRACT

A system and method to control delivery of driving force generated from multiple energy sources to a drive train of a vehicle in motion. In one embodiment, the method includes checking whether the vehicle is in one of a first fuel mode, a second fuel mode, and a third fuel mode, wherein when the vehicle is in the first fuel mode, a first type of fuel is provided to an internal combustion engine, when the vehicle is in the second fuel mode, a second type of fuel is provided to the internal combustion engine, and when the vehicle is in the third fuel mode, no fuel is provided to the internal combustion engine but the drive train is powered by electricity, displaying the status of the current driving mode on a display, receiving a commanding signal for a change of the driving mode, when the change requires a shifting between the first fuel mode and the second fuel mode, and activating a first and a second electric motors to be able to drive the drive train.

### CROSS-REFERENCE TO RELATED PATENT APPLICATION

This application claims the benefit, pursuant to 35 U.S.C. §119(e), of U.S. provisional patent application Ser. No. 61/229,737, filed Jul. 30, 2009, entitled “MULTI-FUEL AND ELECTRIC-DRIVE HYBRID POWER TRAIN AND VEHICLE USING THE SAME,” by Yung Yeung et al., which is incorporated herein by reference in its entirety.

Some references, if any, which may include patents, patent applications and various publications, are cited in a reference list and discussed in the description of this invention. The citation and/or discussion of such references is provided merely to clarify the description of the present invention and is not an admission that any such reference is “prior art” to the invention described herein. All references, if any, listed, cited and/or discussed in this specification are incorporated herein by reference in their entireties and to the same extent as if each reference was individually incorporated by reference.

### FIELD OF THE INVENTION

The present invention relates generally to a hybrid vehicle, and more particularly to a method and system to control delivery of driving force generated from multiple energy sources to a drive train of a vehicle in motion.

### BACKGROUND

Hybrid vehicle now becomes a trend in the society at large in general and in the automobile industry in particular, which normally uses a combination of gasoline and electricity as energy source to provide driving force. Some uses the combination of gasoline and other types of liquid fuels; however, when and how to choose which fuel to use in operation remains a challenge. Furthermore, possible sudden changes in speed and loss of power during the shifting from one liquid fuel to another is a serious concern for both safety and driving pleasure.

Therefore, a heretofore unaddressed need exists in the art to address the aforementioned deficiencies and inadequacies.

### SUMMARY OF THE INVENTION

In one aspect, the present invention provides a vehicle power train. In one embodiment, the vehicle power train includes a drive train configured to drive two front wheels and two rear wheels of a vehicle, a first electric motor engaged with said drive train for compensation for torque interruption, a second electric motor engaged with said drive train through a rear differential for driving the two rear wheels, an electric energy source electrically coupled to said first and second electric motors, an internal combustion engine adapted to provide driving force, a first fuel tank storing a first type of fuel and in fluid communication with the internal combustion engine to provide the first type of fuel to the internal combustion engine during operation, a second fuel tank storing a second type of fuel and in fluid communication with the internal combustion engine to provide the second type of fuel to the internal combustion engine during operation, and a control system configured to permit, in operation, when the first type of fuel is provided to the internal combustion engine through a first type of injector in a first fuel mode, no second type of fuel is provided to the internal combustion engine, and when the second type of fuel is provided to the internal combustion engine through a second type of injector in a second fuel mode, no first type of fuel is provided to the internal combustion engine, wherein the control system is further configured to put the first and second electric motors in action when the internal combustion engine is shifting between the first fuel mode and the second fuel mode.

In one embodiment, the first type of fuel and the second type of fuel are different. In one embodiment, the first type of fuel is compressed natural gas, and the second type of fuel is gasoline.

In one embodiment, the control system is further configured to have a third fuel mode, where neither of the first type of fuel and the second type of fuel is provided to the internal combustion engine, and the drive train is driven by the first and second electric motors only.

In another aspect, the present invention provides a vehicle having the vehicle power train as disclosed above.

In yet another aspect, the present invention relates to a vehicle. In one embodiment, the vehicle includes a vehicle power train having a drive train configured to drive two front wheels and two rear wheels of a vehicle, a first electric motor engaged with said drive train for compensation for torque interruption, a second electric motor engaged with said drive train through a rear differential for driving the two rear wheels, an electric energy source electrically coupled to said first and second electric motors, an internal combustion engine adapted to provide driving force, a first fuel tank storing a first type of fuel and in fluid communication with the internal combustion engine to provide the first type of fuel to the internal combustion engine during operation, a second fuel tank storing a second type of fuel and in fluid communication with the internal combustion engine to provide the second type of fuel to the internal combustion engine during operation, and a control system configured to permit, in operation, when the first type of fuel is provided to the internal combustion engine through a first type of injector in a first fuel mode, no second type of fuel is provided to the internal combustion engine, and when the second type of fuel is provided to the internal combustion engine through a second type of injector in a second fuel mode, no first type of fuel is provided to the internal combustion engine, wherein the control system is further configured to put the first and second electric motors in action when the internal combustion engine is shifting between the first fuel mode and the second fuel mode.

In one embodiment, the control system is further configured to have a third fuel mode, where neither of the first type of fuel and the second type of fuel is provided to the internal combustion engine, and the drive train is driven by the first and second electric motors only.

In a further aspect, the present invention relates to a method to control delivery of driving force generated from multiple energy sources to a drive train of a vehicle in motion. In one embodiment, the method includes checking whether the vehicle is in one of a first fuel mode, a second fuel mode, and a third fuel mode, wherein when the vehicle is in the first fuel mode, a first type of fuel is provided to an internal combustion engine, when the vehicle is in the second fuel mode, a second type of fuel is provided to the internal combustion engine, and when the vehicle is in the third fuel mode, no fuel is provided to the internal combustion engine but the drive train is powered by electricity, displaying the status of the current driving mode on a display, receiving a commanding signal for a change of the driving mode, when the change requires a shifting between the first fuel mode and the second fuel mode, activating a first and a second electric motors to be able to drive the drive train, providing a first type of fuel to the internal combustion engine through a first type of injector when the vehicle is in the first fuel mode, during which mode no second type of fuel is provided to the internal combustion engine; providing a second type of fuel to the internal combustion engine through a second type of injector when the vehicle is in the second fuel mode, during which mode no first type of fuel is provided to the internal combustion engine, and idling the internal combustion engine when the vehicle is in the third fuel mode.

In yet a further aspect, the present invention relates to a vehicle that has a drive train driven by force generated from multiple energy sources. The vehicle includes a controller programmed to administer the steps of checking whether the vehicle is in one of a first fuel mode, a second fuel mode, and a third fuel mode, wherein when the vehicle is in the first fuel mode, a first type of fuel is provided to an internal combustion engine, when the vehicle is in the second fuel mode, a second type of fuel is provided to the internal combustion engine, and when the vehicle is in the third fuel mode, no fuel is provided to the internal combustion engine but the drive train is powered by electricity, displaying the status of the current driving mode on a display, receiving a commanding signal for a change of the driving mode, when the change requires a shifting between the first fuel mode and the second fuel mode, activating a first and a second electric motors to be able to drive the drive train, providing a first type of fuel to the internal combustion engine through a first type of injector when the vehicle is in the first fuel mode, during which mode no second type of fuel is provided to the internal combustion engine, providing a second type of fuel to the internal combustion engine through a second type of injector when the vehicle is in the second fuel mode, during which mode no first type of fuel is provided to the internal combustion engine, and idling the internal combustion engine when the vehicle is in the third fuel mode.

These and other aspects of the present invention will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The drawings described below are for illustration purposes only. The drawings are not intended to limit the scope of the present teachings in any way. The patent or application file may contain at least one drawing executed in color. If so, copies of this patent or patent application publication with color drawing(s) will be provided by the Office upon request and payment of the necessary fee.

FIG. 1 shows an exemplary, three-in-one hybrid power system architecture 100, which utilizes driving power with energy provided by compressed natural gas (“CNG”)—energy source number 1, gasoline—energy source number 2, and electricity from battery—energy source number 3, for various passenger cars, SUVs, and trucks is provided according to one embodiment of the present invention.

FIG. 2 shows a process flow chart for controlling delivery of driving force generated from multiple energy sources to a drive train of a vehicle in motion according to one embodiment of the present invention.

### DETAILED DESCRIPTION

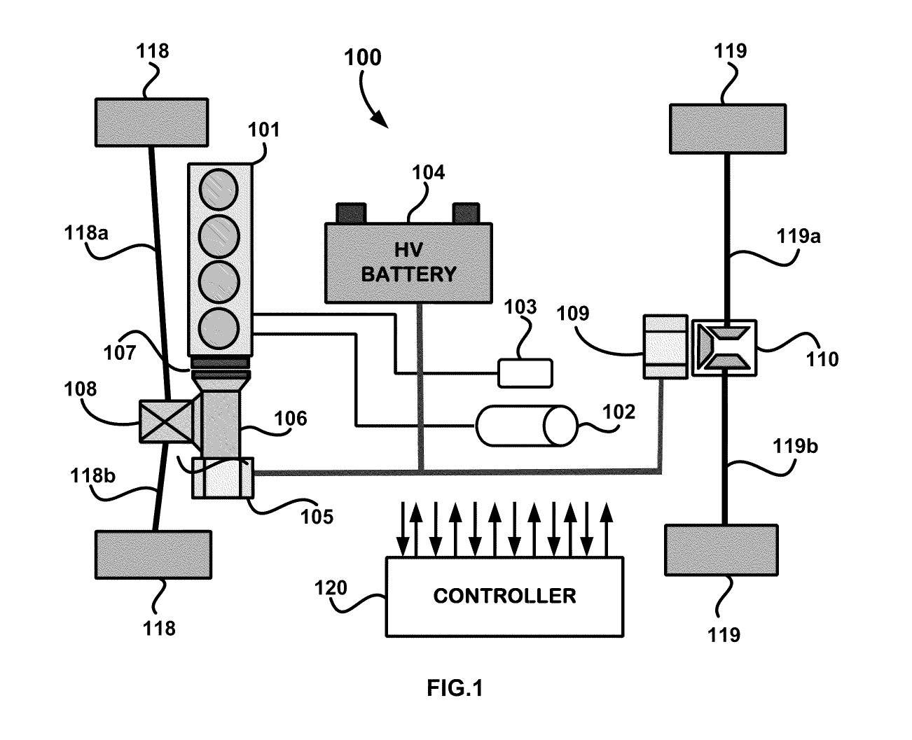

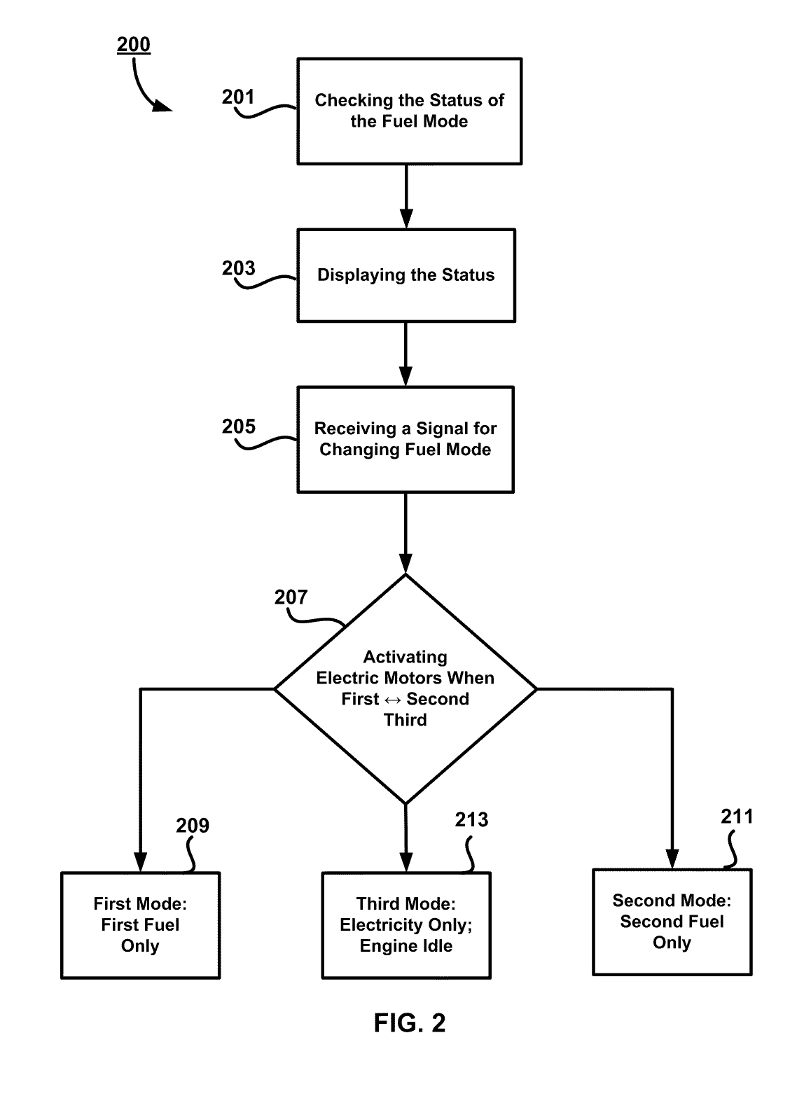

The present invention is more particularly described in the following examples that are intended as illustrative only since numerous modifications and variations therein will be apparent to those skilled in the art. Various embodiments of the invention are now described in detail. Referring to the drawings, FIGS. 1-2, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention. Additionally, some terms used in this specification are more specifically defined below.

### DEFINITIONS

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “compression ratio (CR)” refers to the compression ratio of an internal-combustion engine or external combustion engine, which is a value that represents the ratio of the volume of its combustion chamber; from its largest capacity to its smallest capacity. It is a fundamental specification for many common combustion engines. In a piston engine it is the ratio between the volume of the cylinder and combustion chamber when the piston is at the bottom of its stroke, and the volume of the combustion chamber when the piston is at the top of its stroke.

As used herein, the term “VCR” refers to variable compression ratio technology as known to people skilled in the art.

As used herein, “plurality” means two or more.

As used herein, the terms “comprising,” “including,” “carrying,” “having,” “containing,” “involving,” and the like are to be understood to be open-ended, i.e., to mean including but not limited to.

### OVERVIEW OF THE INVENTION

The present invention provides, among other things, a vehicle power train. In one embodiment, the vehicle power train includes a drive train configured to drive two front wheels and two rear wheels of a vehicle, a first electric motor engaged with said drive train for compensation for torque interruption, a second electric motor engaged with said drive train through a rear differential for driving the two rear wheels, an electric energy source electrically coupled to said first and second electric motors, an internal combustion engine adapted to provide driving force, a first fuel tank storing a first type of fuel and in fluid communication with the internal combustion engine to provide the first type of fuel to the internal combustion engine during operation, a second fuel tank storing a second type of fuel and in fluid communication with the internal combustion engine to provide the second type of fuel to the internal combustion engine during operation, and a control system configured to permit, in operation, when the first type of fuel is provided to the internal combustion engine through a first type of injector in a first fuel mode, no second type of fuel is provided to the internal combustion engine, and when the second type of fuel is provided to the internal combustion engine through a second type of injector in a second fuel mode, no first type of fuel is provided to the internal combustion engine, wherein the control system is further configured to put the first and second electric motors in action when the internal combustion engine is shifting between the first fuel mode and the second fuel mode.

In one embodiment, the first type of fuel and the second type of fuel are different. In one embodiment, the first type of fuel is compressed natural gas, and the second type of fuel is gasoline.

In one embodiment, the control system is further configured to have a third fuel mode, where neither of the first type of fuel and the second type of fuel is provided to the internal combustion engine, and the drive train is driven by the first and second electric motors only.

In another aspect, the present invention provides a vehicle having the vehicle power train as disclosed above.

In yet another aspect, the present invention relates to a vehicle. In one embodiment, the vehicle includes a vehicle power train having a drive train configured to drive two front wheels and two rear wheels of a vehicle, a first electric motor engaged with said drive train for compensation for torque interruption, a second electric motor engaged with said drive train through a rear differential for driving the two rear wheels, an electric energy source electrically coupled to said first and second electric motors, an internal combustion engine adapted to provide driving force, a first fuel tank storing a first type of fuel and in fluid communication with the internal combustion engine to provide the first type of fuel to the internal combustion engine during operation, a second fuel tank storing a second type of fuel and in fluid communication with the internal combustion engine to provide the second type of fuel to the internal combustion engine during operation, and a control system configured to permit, in operation, when the first type of fuel is provided to the internal combustion engine through a first type of injector in a first fuel mode, no second type of fuel is provided to the internal combustion engine, and when the second type of fuel is provided to the internal combustion engine through a second type of injector in a second fuel mode, no first type of fuel is provided to the internal combustion engine, wherein the control system is further configured to put the first and second electric motors in action when the internal combustion engine is shifting between the first fuel mode and the second fuel mode.

The vehicle also includes two front wheels and two rear wheels coupled to the drive train, respectively, and a vehicle frame positioned above the drive drain.

The first type of fuel and the second type of fuel are different. In one embodiment, the first type of fuel is compressed natural gas, and the second type of fuel is gasoline.

In one embodiment, the control system is further configured to have a third fuel mode, where neither of the first type of fuel and the second type of fuel is provided to the internal combustion engine, and the drive train is driven by the first and second electric motors only.

In a further aspect, the present invention relates to a method to control delivery of driving force generated from multiple energy sources to a drive train of a vehicle in motion. In one embodiment, the method includes checking whether the vehicle is in one of a first fuel mode, a second fuel mode, and a third fuel mode, wherein when the vehicle is in the first fuel mode, a first type of fuel is provided to an internal combustion engine, when the vehicle is in the second fuel mode, a second type of fuel is provided to the internal combustion engine, and when the vehicle is in the third fuel mode, no fuel is provided to the internal combustion engine but the drive train is powered by electricity, displaying the status of the current driving mode on a display, receiving a commanding signal for a change of the driving mode, when the change requires a shifting between the first fuel mode and the second fuel mode, activating a first and a second electric motors to be able to drive the drive train, providing a first type of fuel to the internal combustion engine through a first type of injector when the vehicle is in the first fuel mode, during which mode no second type of fuel is provided to the internal combustion engine; providing a second type of fuel to the internal combustion engine through a second type of injector when the vehicle is in the second fuel mode, during which mode no first type of fuel is provided to the internal combustion engine, and idling the internal combustion engine when the vehicle is in the third fuel mode.

The first type of fuel and the second type of fuel are different.

In one embodiment, the first type of fuel is stored in a first fuel tank that is in fluid communication with the internal combustion engine to provide the first type of fuel to the internal combustion engine during operation. The first type of fuel is compressed natural gas.

In one embodiment, the second type of fuel is stored in a second fuel tank that is in fluid communication with the internal combustion engine to provide the second type of fuel to the internal combustion engine during operation. The second type of fuel is gasoline.

In one embodiment, the electricity is provided by a battery.

In yet a further aspect, the present invention relates to a vehicle that has a drive train driven by force generated from multiple energy sources. The vehicle includes a controller programmed to administer the steps of checking whether the vehicle is in one of a first fuel mode, a second fuel mode, and a third fuel mode, wherein when the vehicle is in the first fuel mode, a first type of fuel is provided to an internal combustion engine, when the vehicle is in the second fuel mode, a second type of fuel is provided to the internal combustion engine, and when the vehicle is in the third fuel mode, no fuel is provided to the internal combustion engine but the drive train is powered by electricity, displaying the status of the current driving mode on a display, receiving a commanding signal for a change of the driving mode, when the change requires a shifting between the first fuel mode and the second fuel mode, activating a first and a second electric motors to be able to drive the drive train, providing a first type of fuel to the internal combustion engine through a first type of injector when the vehicle is in the first fuel mode, during which mode no second type of fuel is provided to the internal combustion engine, providing a second type of fuel to the internal combustion engine through a second type of injector when the vehicle is in the second fuel mode, during which mode no first type of fuel is provided to the internal combustion engine, and idling the internal combustion engine when the vehicle is in the third fuel mode.

The first type of fuel and the second type of fuel are different.

In one embodiment, the first type of fuel is stored in a first fuel tank that is in fluid communication with the internal combustion engine to provide the first type of fuel to the internal combustion engine during operation. The first type of fuel is compressed natural gas.

In one embodiment, the second type of fuel is stored in a second fuel tank that is in fluid communication with the internal combustion engine to provide the second type of fuel to the internal combustion engine during operation. The second type of fuel is gasoline.

Additional details are set forth below.

### EXAMPLES

Without intent to limit the scope of the invention, exemplary methods and their related results according to the embodiments of the present invention are given below. Note again that titles or subtitles may be used in the examples for convenience of a reader, which in no way should limit the scope of the invention. Moreover, certain theories are proposed and disclosed herein; however, in no way they, whether they are right or wrong, should limit the scope of the invention.

### Example 1

A Three-in-One Power System Architecture. In one embodiment of the present invention, as shown in FIG. 1, an exemplary, three-in-one hybrid power system architecture 100, which utilizes driving power with energy provided by compressed natural gas (“CNG”)—energy source number 1, gasoline—energy source number 2, and electricity from battery—energy source number 3, for various passenger cars, SUVs, and trucks is provided.

In one embodiment, system 100 is an all-wheel drive hybrid system that is a four-wheel drive combined hybrid power train that incorporates a wide range of unique hybrid functionality while using an efficient layout.

The new three-in-one hybrid power system 100 takes full advantage from a uniquely designed 7H-AMT transmission 106, which is described in more details infra. In one embodiment, all hybrid functions such as engine starting, engine boosting, electric driving in several gears, recuperation for battery charging, compensation of torque interruption during gear shift as well as electric operation of the A/C compressor are all realized by just one electric motor 105. Such integrated technology has significant advantages concerning weight, cost and complexity compared to other hybrid system being under development or being in the market. Depending on the output power of the electric motor 105 and the size and density of battery 104, different levels of hybridization are realized without any other hardware changes. The utilization of a standard dry clutch 107 and proper transmission architecture ensures best powertrain efficiency when operating a vehicle with combustion engine 101. There are several driving modes available based on the system layout. An integrated control system 120 that has a controller and is connected to the clutch and brake actuators as well as other parts to regulate these driving modes.

### Example 2

IC Engine with Two Types of Injectors. In one embodiment of the present invention, internal combustion (“IC”) engine 101, which uses both CNG and gasoline as fuels and hence can be called as a Bi-Fuel Engine, is adapted for achieving higher power, higher efficiency and less CO2 emission by applying various technologies, such as VCR, DVVT, VVL, and twin-turbo charging. The primary fuel is CNG and backup is Gasoline, therefore, there are two different kinds of injectors installed on the engine. Thus, for a four-cylinders engine such as engine 101, there are eight injectors in total: four of them are Solenoid injectors for injecting CNG, and the other four of them are Piezo injectors for injecting gasoline, into engine 101. Direct injection is used for both CNG (side injection mode) and gasoline (central injection mode). One can switch or choose which type of fuels depending on driving mode by utilization of an inventive fuel delivery control system in connection with the integrated control system 120 as set forth in more details below. The IC engine is connected to a 7-speed AMT and can be decoupled from the rest of the powertrain with the help of a friction clutch while electrical drive is taking place by electrical motor EM1.

### Example 3

CNG Tank. In one embodiment of the present invention, a CNG tank is made of aluminum and reinforced with carbon fiber to save weight. The volume of the CNG tank is calculated for maximizing CNG storage based on optimized space and body position on the vehicles which will be held high pressure (around 200 bar). Valve unit for optimum safety and package will be equipped in the tank. A regulator gradually reduces the pressure in the gas that is led to the tank. The gas is then led to a fuel distributor. The fuel is distributed to the four “solenoid” injectors.

### Example 4

Gasoline Tank. In one embodiment of the present invention, The gasoline tank, which is designed for 5 gallons in capacity for emergency use, is connected to the fuel injection system and, eventually, the IC engine, by a series of fuel lines and hoses. The intended tank material is High-density polyethylene (HDPE) or aluminum to reduce weight and meet safety requirements.

### Example 5

Battery. In one embodiment of the present invention, a high energy-density battery 104 is utilized, which is an Li-Ion based battery with energy content raging from 6 KWh to 16 KWh depending on vehicle applications. A plug-in charging system (not shown) can be installed for customer or driver to charge the battery 104 at home or work. The specific power is 830 W/kg, and the specific energy is 97 Wh/kg. In addition, a battery management system in communication with the controller 120 or installed as a part of the controller 120 is utilized for providing management of charging and discharging, monitoring temperature levels and diagnostics, thereby preventing battery 104 from damage or degradation.

### Example 6

Electric Motor One (EM1). In one embodiment of the present invention, two electric motors are utilized. A first electric motor 105, or EM1, is in communication with and engaged to 7H-AMT transmission, will perform engine start, engine boosting, electric driving in several gears, recuperation for battery charging, as well as compensation of torque interruption during gear shift.

### Example 7

7H-AMT Transmission. In one embodiment of the present invention, 7H-AMT transmission 106 is designed and adapted for hybrid vehicle applications. The 7H-AMT 106 is a 3-shaft transmission for transversal configuration with 7 speeds and synchronized one reverse gear. The 7H-AMT 106 is configured to be able to transmit from 165 to 400 Nm engine torque plus 400 Nm E-Motor torque. The 7H-AMT 106 has high efficiency based on conventional manual transmission (“MT”) technology, and corresponding friction is minimized by using advanced dimensioning and new bearing design.

### Example 8

Dual mass flywheel and conventional dry clutch. In one embodiment of the present invention, a dry clutch 107 is engaged and in communication with 7H-AMT transmission 106. Dry clutch 107 is adapted for being able to transmit unlimited input torque from engine 101 to transmission 106, and provides superior mechanical efficiency.

### Example 9

Differential Gear. In one embodiment of the present invention, differential gear 108, which may also be a gear combination, is used to transmit power from transmission 106 to front wheels 118 through output shaft such as half shafts and/or immediate shaft 118a, 118b. The differential gear ratio is selected based on vehicle applications. In one embodiment of the present invention, differential gear 108 is a helical gear and mounted on output shaft 118a, 118b.

### Example 10

Electric Motor Two (EM2). In one embodiment of the present invention, the all-wheel drive function is realized by driving the rear axle by a second electric motor (EM2) 109 and a rear differential unit 110. The power supply to the second electrical motor 109 is provided from the hybrid transmission 106 and the battery 104. The second electric motor 109 is configured to meet electric all wheel drive (“AWD”) speed and battery power requirements so that shift quality under full load can be maintained at the same level as of all wheel drive (“FWD”).

### Example 11

Electrical Rear Differential. In one embodiment of the present invention, rear differential 110 is utilized to distribute power transmitted from the second electric motor 109 to both sides of rear axle 119a, 199b while the wheels are driven and turned at designed speed. The designed speed is realized by selecting gear ratio with respect to rear differential 110. The rear differential 110 is placed halfway between the driving wheels, and mainly composed of drive hypoid pinion, hypoid ring gear, differential case, carrier, and side gears, respectively.

### Example 12

Controller. In one embodiment of the present invention, referring to FIG. 2, controller 120 is programmed to administer a method 200 to control delivery of driving force generated from multiple energy sources to a drive train of a vehicle in motion.

At step 201, controller 120 checks whether the vehicle is in one of a first fuel mode, a second fuel mode, and a third fuel mode, wherein when the vehicle is in the first fuel mode, a first type of fuel is provided to an internal combustion engine, when the vehicle is in the second fuel mode, a second type of fuel is provided to the internal combustion engine, and when the vehicle is in the third fuel mode, no fuel is provided to the internal combustion engine but the drive train is powered by electricity.

At step 203, controller 120 displays the status of the current driving mode on a display (not shown), which may be reviewed by an operator such as the driver of the vehicle.

At step 205, a commanding signal is issued by, for example, the driver, and received by controller 120 for a change of the driving mode.

At step 207, if the change requires a shifting between the first fuel mode and the second fuel mode, controller 120 activates a first and a second electric motors to be able to drive the drive train during the shifting, which ensures a smooth shifting between the modes and avoids dangerous sudden power losing.

At step 209, when the vehicle is in the first fuel mode, a first type of fuel is provided to the internal combustion engine through a first type of injector, during which mode no second type of fuel is provided to the internal combustion engine.

At step 211, when the vehicle is in the second fuel mode, a second type of fuel to the internal combustion engine through a second type of injector, during which mode no first type of fuel is provided to the internal combustion engine.

And at step 213, when the vehicle is in the third fuel mode, the electricity mode, the internal combustion engine is idled: neither of the first type of fuel and the second type of fuel is provided to the engine.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A vehicle power train, comprising:
(a) a drive train configured to drive two front wheels and two rear wheels of a vehicle;
(b) a first electric motor engaged with said drive train for compensation for torque interruption;
(c) a second electric motor engaged with said drive train through a rear differential for driving the two rear wheels;
(d) an electric energy source electrically coupled to said first and second electric motors;
(e) an internal combustion engine adapted to provide driving force;
(f) a first fuel tank storing a first type of fuel and in fluid communication with the internal combustion engine to provide the first type of fuel to the internal combustion engine during operation;
(g) a second fuel tank storing a second type of fuel and in fluid communication with the internal combustion engine to provide the second type of fuel to the internal combustion engine during operation; and
(h) a control system configured to permit, in operation, when the first type of fuel is provided to the internal combustion engine through a first type of injector in a first fuel mode, no second type of fuel is provided to the internal combustion engine, and when the second type of fuel is provided to the internal combustion engine through a second type of injector in a second fuel mode, no first type of fuel is provided to the internal combustion engine, wherein the control system is further configured to put the first and second electric motors in action when the internal combustion engine is shifting between the first fuel mode and the second fuel mode.

2. The vehicle power train of claim 1, wherein the first type of fuel and the second type of fuel are different.

3. The vehicle power train of claim 2, wherein the first type of fuel is compressed natural gas.

4. The vehicle power train of claim 3, wherein the second type of fuel is gasoline.

5. A vehicle having the vehicle power train of claim 1.

6. The vehicle power train of claim 1, wherein the control system is further configured to have a third fuel mode, where neither of the first type of fuel and the second type of fuel is provided to the internal combustion engine, and the drive train is driven by the first and second electric motors only.

7. A vehicle, comprising:
(i) a vehicle power train having:
(a) a drive train configured to drive two front wheels and two rear wheels of a vehicle;
(b) a first electric motor engaged with said drive train for compensation for torque interruption;
(c) a second electric motor engaged with said drive train through a rear differential for driving the two rear wheels;
(d) an electric energy source electrically coupled to said first and second electric motors;
(e) an internal combustion engine adapted to provide driving force;
(f) a first fuel tank storing a first type of fuel and in fluid communication with the internal combustion engine to provide the first type of fuel to the internal combustion engine during operation;
(g) a second fuel tank storing a second type of fuel and in fluid communication with the internal combustion engine to provide the second type of fuel to the internal combustion engine during operation; and
(h) a control system configured to permit, in operation, when the first type of fuel is provided to the internal combustion engine through a first type of injector in a first fuel mode, no second type of fuel is provided to the internal combustion engine, and when the second type of fuel is provided to the internal combustion engine through a second type of injector in a second fuel mode, no first type of fuel is provided to the internal combustion engine, wherein the control system is further configured to put the first and second electric motors in action when the internal combustion engine is shifting between the first fuel mode and the second fuel mode,
(ii) two front wheels and two rear wheels coupled to the drive train, respectively; and
(iii) a vehicle frame positioned above the drive drain.

8. The vehicle of claim 7, wherein the first type of fuel and the second type of fuel are different.

9. The vehicle of claim 8, wherein the first type of fuel is compressed natural gas.

10. The vehicle power train of claim 9, wherein the second type of fuel is gasoline.

11. The vehicle power train of claim 7, wherein the control system is further configured to have a third fuel mode, where neither of the first type of fuel and the second type of fuel is provided to the internal combustion engine, and the drive train is driven by the first and second electric motors only.

12. A method to control delivery of driving force generated from multiple energy sources to a drive train of a vehicle in motion, comprising:
(a) checking whether the vehicle is in one of a first fuel mode, a second fuel mode, and a third fuel mode, wherein when the vehicle is in the first fuel mode, a first type of fuel is provided to an internal combustion engine, when the vehicle is in the second fuel mode, a second type of fuel is provided to the internal combustion engine, and when the vehicle is in the third fuel mode, no fuel is provided to the internal combustion engine but the drive train is powered by electricity;
(b) displaying the status of the current driving mode on a display;
(c) receiving a commanding signal for a change of the driving mode;
(d) when the change requires a shifting between the first fuel mode and the second fuel mode, activating a first and a second electric motors to be able to drive the drive train;
(e) providing a first type of fuel to the internal combustion engine through a first type of injector when the vehicle is in the first fuel mode, during which mode no second type of fuel is provided to the internal combustion engine;
(f) providing a second type of fuel to the internal combustion engine through a second type of injector when the vehicle is in the second fuel mode, during which mode no first type of fuel is provided to the internal combustion engine; and
(g) idling the internal combustion engine when the vehicle is in the third fuel mode.

13. The method of claim 12, wherein the first type of fuel and the second type of fuel are different.

14. The method of claim 13, wherein the first type of fuel is stored in a first fuel tank that is in fluid communication with the internal combustion engine to provide the first type of fuel to the internal combustion engine during operation.

15. The method of claim 14, wherein the first type of fuel is compressed natural gas.

16. The method of claim 13, wherein the second type of fuel is stored in a second fuel tank that is in fluid communication with the internal combustion engine to provide the second type of fuel to the internal combustion engine during operation.

17. The method of claim 16, wherein the second type of fuel is gasoline.

18. The method of claim 12, wherein the electricity is provided by a battery.

19. A vehicle that has a drive train driven by force generated from multiple energy sources, comprising a controller programmed to administer the steps of:
(a) checking whether the vehicle is in one of a first fuel mode, a second fuel mode, and a third fuel mode, wherein when the vehicle is in the first fuel mode, a first type of fuel is provided to an internal combustion engine, when the vehicle is in the second fuel mode, a second type of fuel is provided to the internal combustion engine, and when the vehicle is in the third fuel mode, no fuel is provided to the internal combustion engine but the drive train is powered by electricity;
(b) displaying the status of the current driving mode on a display;
(c) receiving a commanding signal for a change of the driving mode;
(d) when the change requires a shifting between the first fuel mode and the second fuel mode, activating a first and a second electric motors to be able to drive the drive train;
(e) providing a first type of fuel to the internal combustion engine through a first type of injector when the vehicle is in the first fuel mode, during which mode no second type of fuel is provided to the internal combustion engine;
(f) providing a second type of fuel to the internal combustion engine through a second type of injector when the vehicle is in the second fuel mode, during which mode no first type of fuel is provided to the internal combustion engine; and
(g) idling the internal combustion engine when the vehicle is in the third fuel mode.

20. The vehicle of claim 19, wherein the first type of fuel and the second type of fuel are different.

21. The vehicle of claim 20, wherein the first type of fuel is stored in a first fuel tank that is in fluid communication with the internal combustion engine to provide the first type of fuel to the internal combustion engine during operation.

22. The vehicle of claim 21, wherein the first type of fuel is compressed natural gas.

23. The vehicle of claim 22, wherein the second type of fuel is stored in a second fuel tank that is in fluid communication with the internal combustion engine to provide the second type of fuel to the internal combustion engine during operation.

24. The vehicle of claim 23, wherein the second type of fuel is gasoline.

25. The vehicle of claim 19, wherein the electricity is provided by a battery.
